(19) United States
(12) Patent Application Publication
(10) Pub. No.: US 2016/0098395 A1
(43) Pub. Date: Apr. 7, 2016

(54) SYSTEM AND METHOD FOR SEPARATE AUDIO PROGRAM TRANSLATION

(71) Applicant: CHARTER COMMUNICATIONS OPERATING, LLC, St. Louis, MO (US)

(72) Inventor: Kreig DuBose, Portland, OR (US)

(73) Assignee: CHARTER COMMUNICATIONS OPERATING, LLC, St. Louis, MO (US)

(21) Appl. No.: 14/503,532

(22) Filed: Oct. 1, 2014

(51) Int. Cl. G06F 17/28; G10L 15/26; G10L 13/00

(52) U.S. Cl. CPC G06F 17/289; G10L 13/00; G10L 15/26

(57) ABSTRACT

Systems, methods and apparatus providing language translation of a media stream by deriving, at a media routing device, an initial language plaintext representation of audio information associated with an input media stream, translating the initial language plaintext representation to provide a target language plaintext representation, applying text-to-speech processing to the target language plaintext representation to provide corresponding target language audio information associated with the input media stream, combining the corresponding target language audio information with the received media stream to provide thereby an output media stream.

### FIELD OF THE INVENTION

The invention relates to translating audio information associated with live or prerecorded content from an initial language to a target language and, more particularly but not exclusively, to providing an efficient mechanism for generating a target language secondary audio program (SAP) for broadcast or streamed content.

### BACKGROUND

Presently, television programming, movies and other content comprise video data and audio data, wherein the audio data may comprise an initial or primary audio track according to an initial language (e.g., English) as well as one or more secondary audio programs (SAPs) according to target languages (e.g., Spanish, French, Chinese etc.). The process of generating each SAP is relatively laborious; typically involving skilled translators viewing the content with the initial audio track and translating (i.e., “dubbing”) the initial audio track to provide the corresponding SAP. In some cases, skilled voice actors conversant in a target language are used to create the SAP using a translated script of the content.

Closed captioning (CC) is known. CC generally comprises a textual representation of contemporaneously presented audio information overlayed by a presentation device over corresponding video information of audiovisual content. CC textual information may be extracted from a television signal, data associated with an audiovisual signal, or generated “on-the-fly” using voice recognition processes, such as might be found within the context of an evening news show newsreader. Due to processing time, on-the-fly CC processing provides textual information that often significantly lags in time the audio information from which it is derived. However, automatically generated CC textual information avoids the need for skilled human interaction. CC textual information may also be generated using a script associated with a movie or television show.

### SUMMARY

Various deficiencies in the prior art are addressed by systems, methods, apparatus and other mechanisms providing substantially real-time language translation of audio information such as associated with video content. Various embodiments provide an efficient mechanism for generating a target language secondary audio program (SAP) for broadcast or streamed content, illustratively responsive to a user selected option that may or may not be known a priori to the translation device or appliance.

For example, a method according to one embodiment provides language translation of a media stream by deriving, at a media routing device, an initial language plaintext representation of audio information associated with an input media stream, translating the initial language plaintext representation to provide a target language plaintext representation, applying text to speech processing to the target language plaintext representation to provide corresponding target language audio information associated with the input media stream, combining the corresponding target language audio information with the received media stream to provide thereby an output media stream.

### BRIEF DESCRIPTION OF THE DRAWING

The teachings of the present invention can be readily understood by considering the following detailed description in conjunction with the accompanying drawing, in which:

FIG. 1 depicts a high-level block diagram of a system according to one embodiment;

FIG. 2 depicts a flow diagram of a method according to various embodiments; and

FIG. 3 depicts a high-level block diagram of a computer suitable for use in performing the functions described herein.

To facilitate understanding, identical reference numerals have been used, where possible, to designate identical elements that are common to the figures.

### DESCRIPTION

The invention will be primarily described within the context of systems, methods, apparatus and other mechanisms providing substantially real-time language translation of initial language audio information such as associated with video content to provide, illustratively, a target language separate audio program (SAP). However, those skilled in the art and informed by the teachings herein will realize that the invention is also applicable to other translation applications.

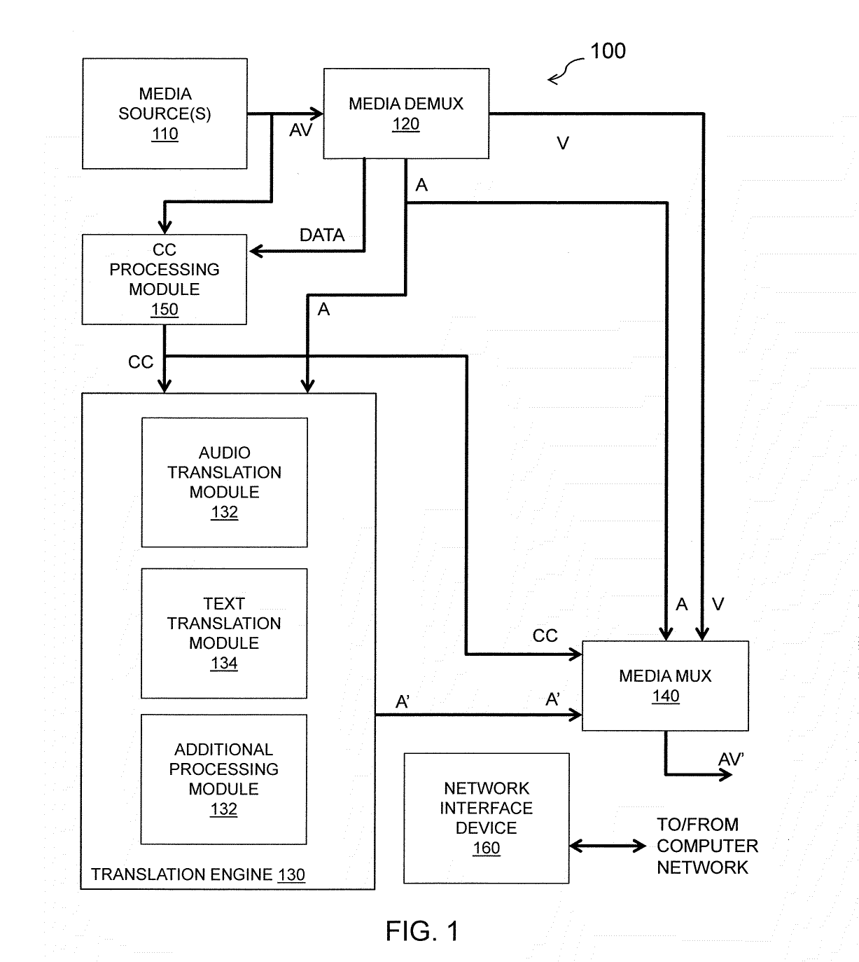

FIG. 1 depicts a high-level block diagram of language translation system according to one embodiment. Generally speaking, the language translation system 100 of FIG. 1 is adapted to translate voice or other initial language audio information associated with an initial media stream to provide target language audio information suitable for association with the media stream as, illustratively, a separate audio program (SAP).

The system 100 may be used within the context of a content server, a head end or neighborhood server within a cable television or other content distribution system and the like. The system 100 may be implemented within the context of any device routing media from a source to a destination, such as from a content server to a subscriber terminal or set top box (STB).

Generally speaking, the system 100 receives from a source device (e.g., a server or other content source or distribution element) an input media stream comprising content according to a first language (e.g., movies, television programs and/or other audiovisual content), and processes audio information associated with the received media stream to provide an output media stream comprising content according to a second (or more) language suitable for transmission to a destination device.

Specifically, the system 100 of FIG. 1 comprises, illustratively, a media combiner/demultiplexer 120, and translation engine 130, a media multiplexer 140 and an optional closed captioning (CC) processing module 150. The system 100 of FIG. 1 is depicted as receiving audiovisual content AV from, illustratively, one or more media sources 110 such as remote content servers, network/broadcast feeds and the like. The system 100 of FIG. 1 is depicted as including a network interface device 160 operatively coupled to a computer network (e.g., cable television access network and the like) and configured to support data communications between various local and remote elements of the language translation system 100 as described herein.

It will be appreciated by those skilled in the art that the simplified system depicted herein includes various other components/modules within the context of the depicted embodiment, such as those associated with stream buffering, stream synchronization, stream/traffic flow management and so on.

The system 100 of FIG. 1 depicts the media demultiplexer 120 receiving and demultiplexing a media stream AV provided by the media source(s) 110 to extract therefrom a video stream V and an initial language audio stream A. The video stream V is coupled to the media multiplexer 140. The initial language audio stream A is coupled to the translation engine 130 and the media multiplexer 140.

The translation engine 130 translates the initial language audio stream A to produce a translated audio stream A′ which is coupled to the media multiplexer 140.

The translation engine 130 is depicted as including an audio translation module 132, a text translation module 134 and additional processing modules 136. In various embodiments, only the audio translation module 132 is used. In various other embodiments, only the text translation module 134 is used. In still other embodiments, both the audio translation module 132 and text translation module 134 are used. In various embodiments, the additional processing modules 136 are used along with one or both of the audio translation module 132 and text translation module 134 to provide, illustratively, increased accuracy of text/audio information by iteratively improving such text/audio information using additional or multiple sources of data representing the underlying or initial audio information.

The audio translation module 132 comprises, illustratively, a natural language translation module operable to translate an initial language audio stream A to produce there from a translated audio stream A′. The audio translation module 132 will be described in more detail below. The audio translation module 132 may be implemented locally or remotely or a combination thereof.

The text translation module 134 comprises, illustratively, a text-to-text translation module operable to translate a text representation of the initial language audio stream A to produce a text representation of a corresponding translated audio stream A′. The text translation module 134 will be described in more detail below. For example, various embodiments utilize text representations of content such as Descriptive Video Service (DVS) text, closed caption text and the like. The text translation module 134 may be implemented locally or remotely or a combination thereof.

Various additional processing modules 136 may also be used within the context of various embodiments. Moreover, combinations of one or more of the audio translation module 132, text translation module 134 and additional processing module 136 may also be used within the context of various embodiments.

In various embodiments, the translation engine 130 is implemented within the context of a computing device or computing appliance specifically adapted to perform the functions described herein. In such embodiments, the audio translation module 132, text translation module 134 and additional processing module 136 may be implemented within the context of hardware or a combination of hardware and software, as will be described in more detail below.

The optional CC processing module 150 provides closed captioning (CC) information to the translation engine 130, such as a stream of text corresponding to the initial language audio stream A included within the received media stream AV.

In various embodiments, the CC processing module 150 operates in an “on-the-fly” manner using a voice recognition mechanism to generate CC information in response to the initial language audio stream A, which may be received directly from the media source 110 (as shown) or may be demultiplexed by the media demultiplexer 120 (not shown).

In various embodiments, the CC processing module 150 receives a data stream DATA including CC data directly from the media source 110 (not shown) or from the media demultiplexer 120 (as shown). CC data may be included in interstitial portions of an analog television signal or digital equivalent, in data fields of a compressed video stream, or externally specified file or ancillary stream (e.g., eXtensible Markup Language (XML), DVS data, CC data and the like).

The media multiplexer 140 produces a multiplexed output stream AV′ comprising the video stream V and one or both of the initial language audio stream A and corresponding translated audio stream A′. In various embodiments, the translated audio stream A′ replaces the initial language audio stream A. in various embodiments, the translated audio stream A′ is provided as an SAP along with the initial language audio stream A. In various embodiments, the CC data generated by or received by the CC processing module 150 is included within the multiplexed output stream AV′.

Generally speaking, various embodiments implement a mechanism by which natural language processing and/or other techniques are used to translate voice or other initial language audio information into target language audio information. For example, various embodiments contemplate translation of initial language audio information into target language audio information, such as translating a primary audio associated with a television channel, streaming media, on-demand content and the like into a target language for use as a Secondary Audio Program (SAP).

In various embodiments, a natural language processing module performs translations “on-the-fly” such as translating English language audio associated with a British television newsreader into French or some other language to be included as an SAP associated with the broadcast.

In various embodiments, a translation module directly translates the initial language audio into target language audio.

In various embodiments, a translation module utilizes a closed caption (CC) output or other textual representation of the initial language audio. For example, CC information or other textual language representations may be used to represent the initial language audio of content to be broadcast via a television channel or provided to subscribers within the context of a video-on-demand (VOD) system.

The CC information may be generated in a standard manner to provide an initial language plain text version of the audio. The CC information may be generated using standard voice-recognition mechanisms. The CC information may be generated “on-the-fly” such as for a live television program (less accurate, more synchronization errors), or generated by a combination of voice-recognition mechanisms and post-processing to improve accuracy and reduce synchronization errors.

The initial language or plain text version of the audio may then be translated using text-to-text translation mechanisms to provide a target language plain text version of the audio. The target language plain text version of the audio may then be processed using text-speech conversion mechanisms to provide a target language version of the audio.

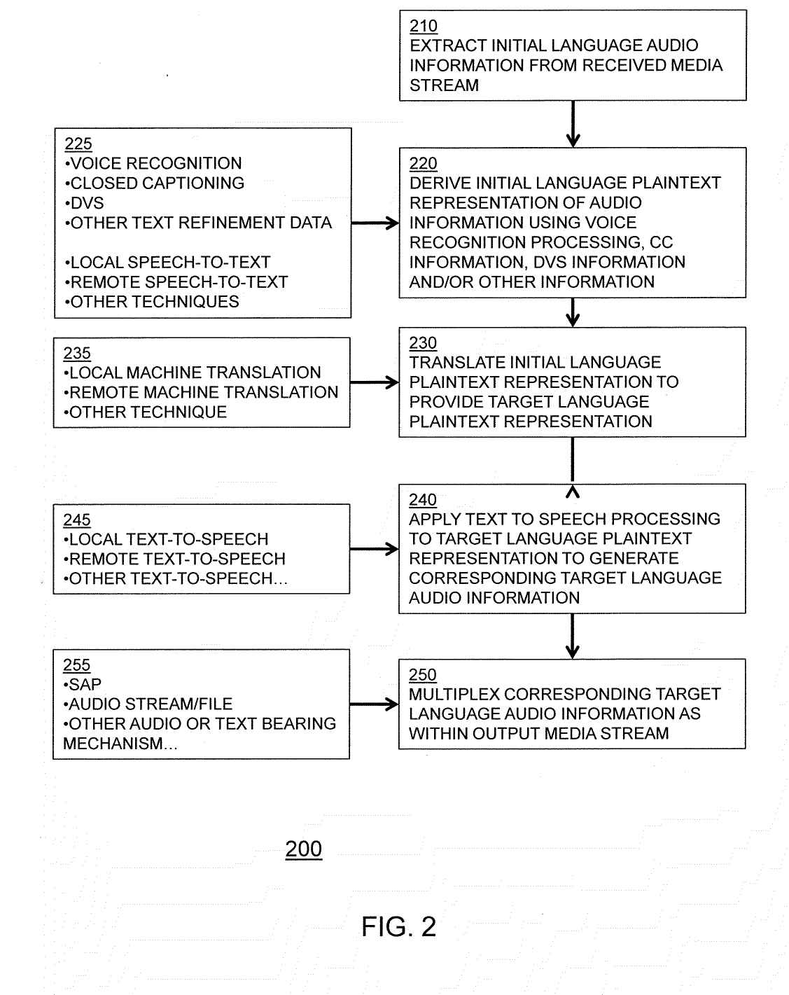

FIG. 2 depicts a flow diagram of a method according to various embodiments. The method 200 of FIG. 2 is well adapted for use at a media server or content server within an information distribution system, a media distribution node such as within a cable television system, satellite television distribution system, wireless or wireline content distribution system or network, optical content distribution system or network and so on.

At step 210, initial language audio information is extracted from a received media stream. The audio information may be extracted via a media demultiplexer 120 such as depicted above with respect to the system 100 of FIG. 1 or any other means.

At step 220, a plaintext representation of the extracted initial language audio information is derived using voice recognition processing of the extracted initial language audio information, using CC information, using DVS information and/or using other information. For example, in various embodiments voice recognition processing is applied to the initial language audio information to derive a corresponding initial language plaintext representation of the initial language audio information. This initially derived plaintext representation may be further refined in terms of accuracy using CC data, DVS data and the like. Referring to box 225, the initially derived plaintext representation may be provided using voice recognition, closed captioning data, DVS data and or other text refinement data. Further, voice recognition processing may be provided via a local or remote speech-to-text processing engine, such as the speech-to-text products provided by Google Inc., Microsoft Inc., Nuance Inc. and/or other companies.

In various embodiments, a standardized or common format or code is defined to enable rapid translation of text (e.g., CC, DVS and the like) from one language to another. That is, textual representations of content are initially generated according to the standard format such that subsequent translation and/or other processing is simplified. In this manner, a slightly increased upfront cost (to accurately code the file) is off-set by the ability to very accurately translate content descriptive text to other languages.

In various embodiments, the voice-recognition processing is only applied to the initial language audio information if necessary to derive the initial language plaintext representation. If the plaintext representation is included or multiplexed within the received media stream, then the included plaintext representation may be used. Such included plaintext representation may comprise closed captioning (CC) information or other data.

At step 230, the initial language plaintext representation is translated to provide a target language plaintext representation. Referring to box 235, the plaintext translation processing may be provided via a local or remote text translation engine, such as the machine translation products provided by Google Inc., Microsoft Inc., Nuance Inc. and/or other companies.

At step 240, text-to-speech processing is applied to the target language plaintext representation to generate corresponding target language audio information. Referring to box 245, the text-to-speech processing may be provided via a local or remote text-to-speech engine, such as the text-to-speech products provided by Google Inc., Microsoft Inc., Nuance Inc. and/or other companies.

At step 250, the corresponding target language audio information is multiplexed with an output media stream. Referring to box 255, the target language audio information may be provided as a SAP within that media stream, as a separate audio stream/file or in some other audio or text bearing mechanism.

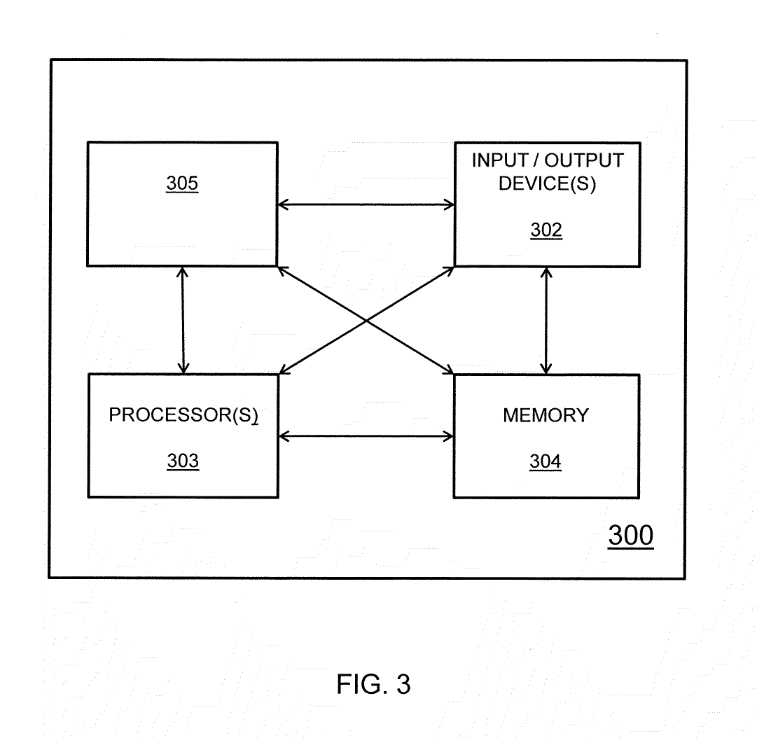

FIG. 3 depicts a high-level block diagram of a computing device, such as a processor in a content distribution network element, suitable for use in performing functions described herein such as those associated with the various elements described herein with respect to the figures.

As depicted in FIG. 3, computing device 300 includes a processor element 303 (e.g., a central processing unit (CPU) and/or other suitable processor(s)), a memory 304 (e.g., random access memory (RAM), read only memory (ROM), and the like), a cooperating module/processor 305, and various input/output devices 306 (e.g., a user input device (such as a keyboard, a keypad, a mouse, and the like), a user output device (such as a video presentation or display device, an audio presentation device or speaker, and so on), an input port, an output port, a receiver, a transmitter, and storage devices (e.g., a persistent solid state drive, a hard disk drive, a compact disk drive, and the like)).

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating processor 305 can be loaded into memory 304 and executed by processor 303 to implement the functions as discussed herein. Thus, cooperating processor 305 (including associated data structures) can be stored on a computer readable storage medium, e.g., RAM memory, magnetic or optical drive or diskette, and the like.

It will be appreciated that computing device 300 depicted in FIG. 3 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product comprising a non-transitory computer readable medium storing instructions for causing a processor to implement the methods and/or techniques described herein are invoked or otherwise provided. Instructions for invoking the inventive methods may be stored in tangible and non-transitory computer readable media such as fixed or removable media or memory, and/or stored within a memory within a computing device operating according to the instructions.

In at least some embodiments, an apparatus includes a processor and a memory communicatively connected to the processor. The processor is configured to provide language translation of a media stream, such as by deriving, at a media routing device, an initial language plaintext representation of audio information associated with an input media stream, translating the initial language plaintext representation to provide a target language plaintext representation, applying text to speech processing to the target language plaintext representation to provide corresponding target language audio information associated with the input media stream, and combining the corresponding target language audio information with the received media stream to provide thereby an output media stream.

Thus, various embodiments contemplate systems, apparatus, methods and the like for providing language translation of a media stream, such as by deriving, at a media routing device, an initial language plaintext representation of audio information associated with an input media stream, translating the initial language plaintext representation to provide a target language plaintext representation, applying text to speech processing to the target language plaintext representation to provide corresponding target language audio information associated with the input media stream, and combining the corresponding target language audio information with the received media stream to provide thereby an output media stream. The step of driving may be performed by extracting initial language audio data from the input media stream, and applying local or remote speech-to-text processing to the extracted initial language audio data to derive therefrom the initial language plaintext representation of audio information associated with the input media stream. The step of driving may comprise extracting closed captioning (CC) data from the input media stream and/or extracting Descriptive Video Service (DVS) text from the input media stream, either of which may be used to improve the accuracy of the initial language plaintext representation. The corresponding target language audio information may be combined with received media stream as a separate file or as a Secondary Audio Program (SAP).

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method for providing language translation of a media stream, comprising:
deriving, at a media routing device, an initial language plaintext representation of audio information associated with an input media stream;
translating the initial language plaintext representation to provide a target language plaintext representation;
applying text-to-speech processing to the target language plaintext representation to provide corresponding target language audio information associated with the input media stream; and
combining the corresponding target language audio information with the received media stream to provide thereby an output media stream.

2. The method of claim 1, wherein said step of deriving comprises:
extracting initial language audio data from the input media stream; and
applying speech-to-text processing to the extracted initial language audio data to derive therefrom the initial language plaintext representation of audio information associated with the input media stream.

3. The method of claim 1, wherein said step of deriving comprises extracting closed captioning (CC) data from the input media stream.

4. The method of claim 1, wherein said step of deriving comprises extracting Descriptive Video Service (DVS) text from the input media stream.

5. The method of claim 2, further comprising using closed captioning (CC) data associated with the input media stream to improve the accuracy of the initial language plaintext representation.

6. The method of claim 2, further comprising using Descriptive Video Service (DVS) text associated with the input media stream to improve the accuracy of the initial language plaintext representation.

7. The method of claim 1, wherein the corresponding target language audio information is combined with the received media stream as a Secondary Audio Program (SAP).

8. The method of claim 1, wherein translating the initial language plaintext representation comprises:
forwarding the initial language plaintext representation toward a machine translation engine associated with a remote server; and
receiving the target language plaintext representation from the remote server.

9. The method of claim 1, wherein applying text-to-speech processing comprises:
forwarding the target language plaintext representation toward a text-to-speech processing engine associated with a remote server; and
receiving the target language audio information from the remote server.

10. A method for generating a separate audio program (SAP) for a media stream, comprising:
extracting initial language audio information from a media stream including corresponding video information;
applying voice recognition processing to the initial language audio information to derive therefrom a corresponding initial language plain text representation;
translating the initial language plaintext representation to provide a target language plaintext representation;
applying text-to-speech processing to the target language plaintext representation to generate corresponding target language audio information; and
multiplexing the corresponding target language audio information as a SAP within the media stream.

11. A content distribution element, comprising a processor configured for:
extracting initial language audio information from a media stream including corresponding video information;
applying voice recognition processing to the initial language audio information to derive therefrom a corresponding initial language plain text representation;
translating the initial language plaintext representation to provide a target language plaintext representation;
applying text-to-speech processing to the target language plaintext representation to generate corresponding target language audio information; and
multiplexing the corresponding target language audio information as a SAP within the media stream.

12. A tangible and non-transient computer readable storage medium storing instructions which, when executed by a computer, adapt the operation of the computer to provide a method for providing language translation of a media stream, comprising:
deriving, at a media routing device, an initial language plaintext representation of audio information associated with an input media stream;
translating the initial language plaintext representation to provide a target language plaintext representation;
applying text-to-speech processing to the target language plaintext representation to provide corresponding target language audio information associated with the input media stream; and
combining the corresponding target language audio information with the received media stream to provide thereby an output media stream.

13. The computer readable storage medium of claim 12, wherein said step of deriving comprises:
extracting initial language audio data from the input media stream; and
applying speech to text processing to the extracted initial language audio data to derive therefrom the initial language plaintext representation of audio information associated with the input media stream.

14. A computer program product wherein computer instructions, when executed by a processor in a content distribution network element, adapt the operation of the content distribution network element to provide a method for providing language translation of a media stream, comprising:
deriving, at a media routing device, an initial language plaintext representation of audio information associated with an input media stream;
translating the initial language plaintext representation to provide a target language plaintext representation;
applying text-to-speech processing to the target language plaintext representation to provide corresponding target language audio information associated with the input media stream; and
combining the corresponding target language audio information with the received media stream to provide thereby an output media stream.
